(19) United States
(12) Patent Application Publication
(10) Pub. No.: US 2018/0281170 A1
(43) Pub. Date: Oct. 4, 2018

(54) TOOL HOLDER ASSEMBLY

(71) Applicant: CHANG-YU TSAI, Taichung (TW)

(72) Inventor: CHANG-YU TSAI, Taichung (TW)

(21) Appl. No.: 15/472,313

(22) Filed: Mar. 29, 2017

(51) Int. Cl. B25H 3/00; B25H 3/04; B65D 21/02

(52) U.S. Cl. CPC B25H 3/003; B25B 15/008; B65D 21/0201; B25H 3/04

(57) ABSTRACT

A tool holder assembly includes multiple bases and multiple pivots. Each base has a first pivotal portion formed axially thereto, a first passage defined through the first pivotal portion, and a second pivotal portion formed axially thereto. One tool extends through the first passage. One of multiple pivots extends through the two holes of the two extensions of one base and the first passage of another base, such that the bases are pivotable relative to each other.

### BACKGROUND OF THE INVENTION

### 1. Fields of the Invention

The present invention relates to a tool holder assembly, and more particularly, to a tool holder assembly for L-shaped wrenches, and comprising multiple bases and each base has a tool connected thereto, the bases are pivotable relative to others.

### 2. Descriptions of Related Art

The conventional too holder assembly as disclosed in U.S. Pat. No. 2,776,744 comprises a holder with a first body and a second body. The first body is pivotable about the pivotal portion relative to the second body so as to arrange the first and second bodies to be L-shaped or parallel arrangement. The first body receives multiple tools of different sizes. The second body receives other tools therein. However, there are only two different arrangements when operating the first body relative to the second body, and this restricts the use of the tools. Besides, when picking one of the tools, the tools that are larger than the one the user needs have to be pivoted so that the one needed can be picked up.

The present invention intends to provide a tool holder assembly that eliminates the shortcomings mentioned above.

### SUMMARY OF THE INVENTION

The present invention relates to a tool holder assembly and comprises multiple bases and multiple pivots. Each base has a first pivotal portion formed axially thereto, a first passage defined through the first pivotal portion, and a second pivotal portion formed axially thereto. One tool extends through the first passage. One of multiple pivots extends through the two holes of the two extensions of one base and the first passage of another base, such that the bases are pivotable relative to each other.

The pivot extends through the second pivotal portion of one base and the first passage of the next base so that each of the bases is pivotable about the second pivotal portion to be a desired position. When picking one of the tools, the user pivots the base having that tool, and the tool to be picked out is not affected by the larger tool located beside it. There are multiple bases for the tool holder assembly and the bases are able to be rolled up as a roll for convenience of storage.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the tool holder assembly of the present invention;

FIG. 2 is a perspective view to show the base of the tool holder assembly of the present invention;

FIG. 3 is a perspective view to show the pivot of the tool holder assembly of the present invention;

FIG. 4 is a perspective view to show the tool holder assembly of the present invention;

FIG. 5 is a front view of the tool holder assembly of the present invention;

FIG. 6 is a cross sectional view, taken along line 6-6 in FIG. 5;

FIG. 7 shows the second operational status of the tool holder assembly of the present invention;

FIG. 8 shows the third operational status of the tool holder assembly of the present invention;

FIG. 9 shows the fourth operational status of the tool holder assembly of the present invention, and

FIG. 10 is an exploded view of the second embodiment of the tool holder assembly of the present invention.

### DETAILED DESCRIPTION OF THE PREFERRED EMBODIMENT

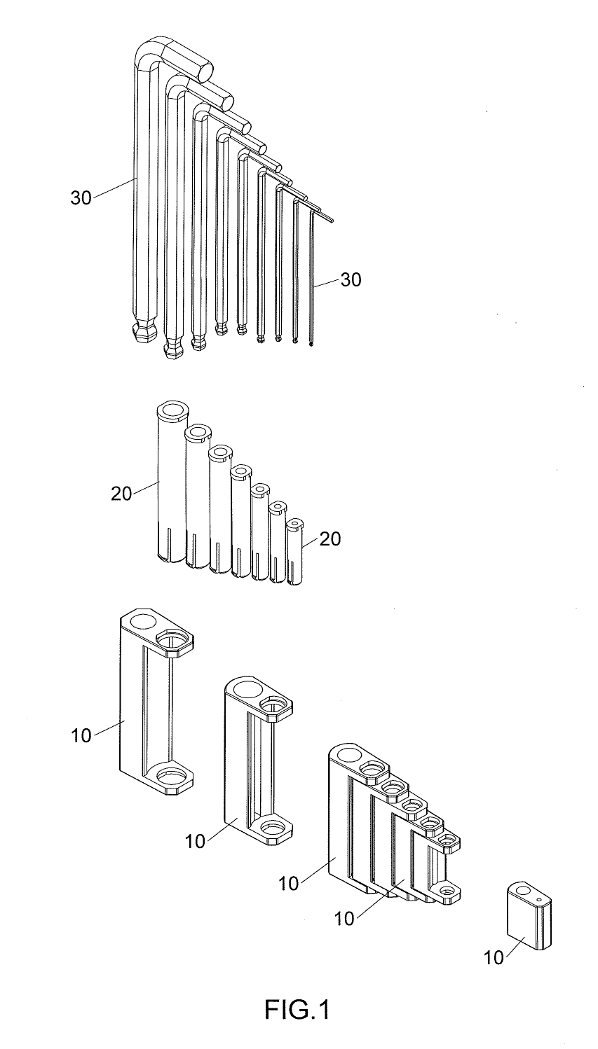

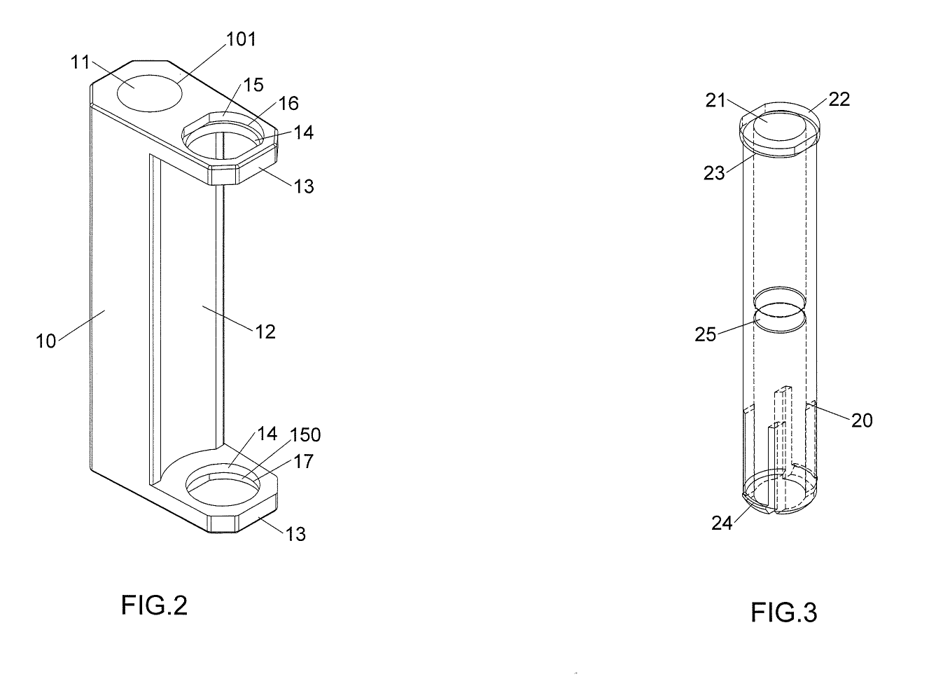

Referring to FIGS. 1 to 3, the tool holder assembly of the present invention comprises multiple bases 10 of different sizes, and multiple pivots 20. The bases 10 are arranged from big to small in sequence and pivotably connected to each other. Each base 10 comprises a first pivotal portion 101 formed axially thereto, and a first passage 11 is defined through the first pivotal portion 101. A second pivotal portion 12 is formed axially to each base 10 and has an open side. Two extensions 13 respectively extend from laterally from the top end and the bottom end of the second pivotal portion 12 of each base 10. Each extension 13 has a circular hole 14 defined therethrough. A first recessed area 15 is defined in the top of the extension 13 that extends from the top end of each base 10, and the first recessed area 15 communicates with the hole 14 corresponding thereto. A first shoulder 16 is formed at the connection portion between the first recessed area 15 and the periphery of the hole 14 corresponding thereto. A second recessed area 150 is defined in the bottom of the extension 13 that extends from the bottom end of each base 10. The second recessed area 150 communicates with the hole 14 corresponding thereto. A second shoulder 17 is formed at the connection portion between the second recessed area 150 and the periphery of the hole 14 corresponding thereto.

One of multiple pivots 20 extends through the two holes 14 of the two extensions 13 of one base 10 and the first passage 11 of another base 10 to pivotably connect the two bases 10. Each of the bases 10 has one tool 30 extending through the first passage 11 thereof. The number of the bases 10 can be 2, 3, 4, 5, 6, 7, 8, 9, 10 or 12.

The pivots 20 are different in sizes and are arranged in sequence. Each pivot 20 is a cylindrical member and has a second passage 21. A first flange 22 and a second flange 24 respectively extend radially from two ends of each pivot 20. The tool 30 extends through the second passage 21. The pivot 20 extends through the two holes 14 of the two extensions 13 of one base 10, and the first pivotal portion 101 of another base 10. The first flange 22 is engaged with the first recessed area 15 and has an engaging portion 23 on the underside thereof. It is noted that the first recessed area 15 of each of the at least two bases 10 is a non-circular area, and the first flange 22 is a non-circular flange so as to be engaged with the first recessed area 15. The engaging portion 23 is rested on the first shoulder 16. The second flange 24 is rested on the second shoulder 17. The pivot 20 is restricted by the first and second shoulders 16, 17, the engaging portion 23 and the second flange 24 so as not to be separated from the base 10 corresponding thereto.

The tools 30 can be a hand tool or a hexagonal wrench, and two ends of the tool 30 are exposed beyond the second passage 21. The second passage 21 of each pivot 20 includes a restriction portion 25 extending from the inner periphery thereof so as to position the tool 30 in the second passage 21. The tool 30 can be pulled out from the second passage 21 by force. The number of the tools 30 is one more than the number of the bases 10. The first one of the bases 10 does not need the pivot 20 to extend through the first passage 11, and one tool 30 extends through the first passage 11 of the first one of the bases 10. The last one of the bases 10 does not need the second pivotal portion 12, and one tool 30 extends through the holes 14 of the last one of the bases 10.

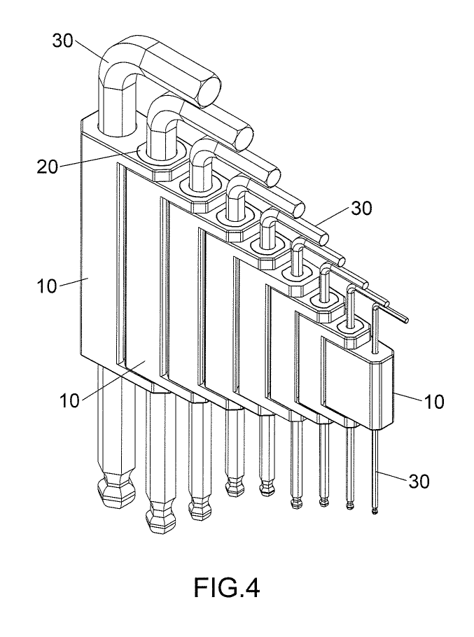

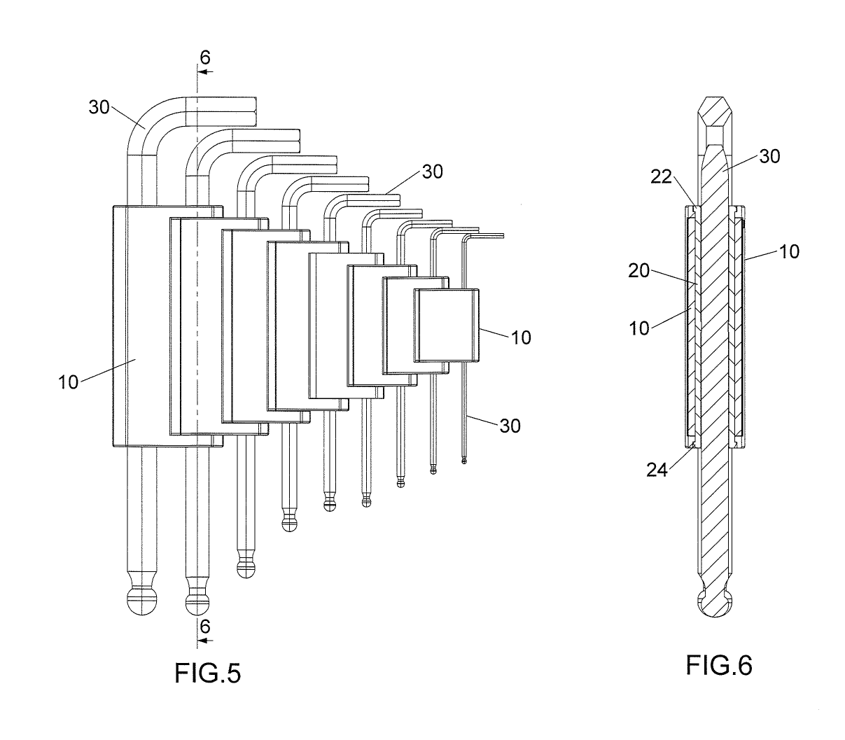

As shown in FIGS. 4 to 6, each base 10 is pivotable about the pivot 20 that extends through the holes 14. The first flange 22 of the pivot 20 is received in the first recessed area 15, and the engaging portion 23 is rested on the first shoulder 16. The second flange 24 is rested on the second shoulder 17 to that the pivot 20 does not separate from the two bases 10. The tools 30 are positioned in the pivots 20.

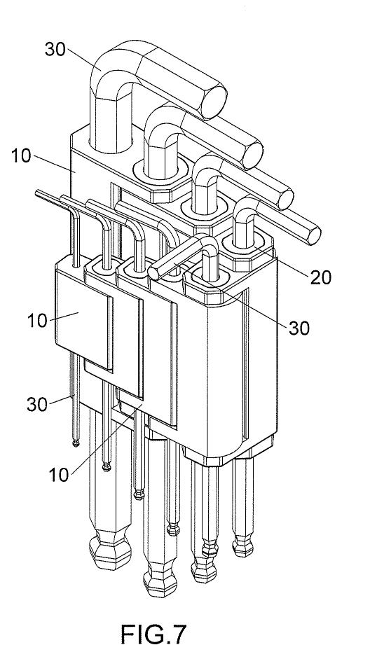

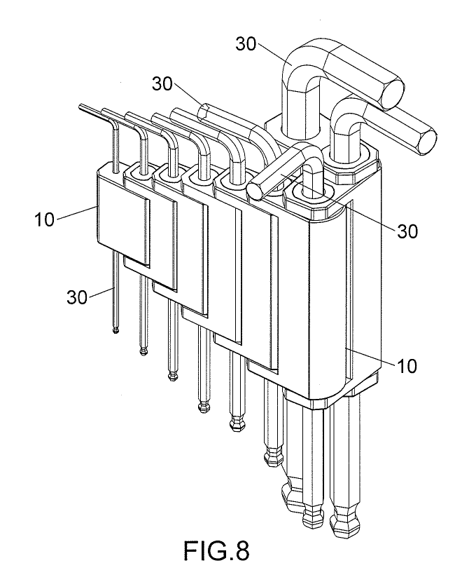

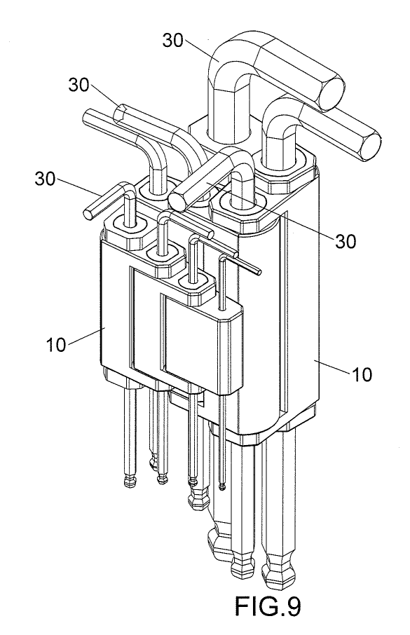

As shown in FIGS. 7 to 9, every two of the bases 10 can be pivoted relative to each other. When the user wants to pick one of the tools 30, the base 10 that has the tool 30 needed is pivoted to be about perpendicular to the next base 10 so that the tool 30 needed does not affected by the larger tool 30 located next to it. The tool 30 needed can be easily picked out from the pivot 20. There are at least four operational statuses available.

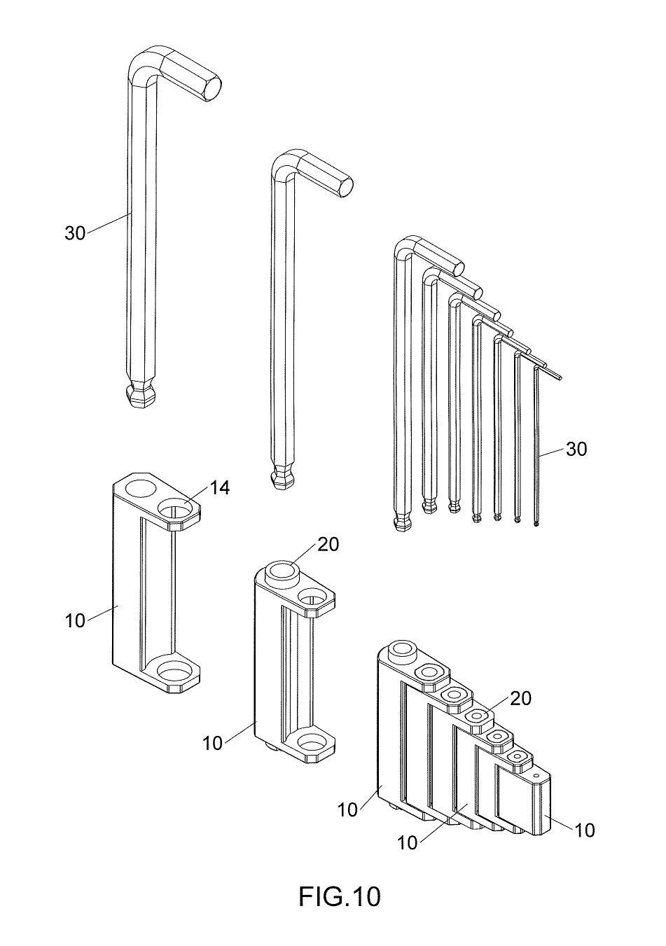

FIG. 10 shows the second embodiment, wherein the base 10 does not have the first recessed area 15, the first shoulder 16 and the second shoulder 17. The pivot 20 is integrally formed with the base 10 corresponding thereto, and extends through the first pivotal portion 101. The two ends of the pivot 20 are slightly exposed from two ends of the base 10. The pivot 20 is applied by a force to extend through the holes 14 of the base 10.

The advantages of the present invention are that each pivot 20 extends through the holes 14 of one base 10 and the first passage 11 of the next base 10, so that the two bases 10 are pivotable relative to each other.

As shown in FIGS. 7 to 9, when the user wants to pick one of the tools 30, the base 10 that has the tool 30 needed is pivoted to be about perpendicular to the next base 10 so that the tool 30 needed does not affected by the larger tool 30 located next to it. The tool 30 needed can be easily picked out from the pivot 20.

As shown in FIGS. 4, 7, 8 and 9, each pivot 20 extends through the holes 14 of one base 10 and the first passage 11 of the next base 10, so that the two bases 10 are pivotable relative to each other. There are multiple operational statuses available.

The tool holder assembly can be rolled up to be a roll which is easily stored and carried.

Each pivot 20 is restricted by the first shoulder 16, the second shoulder 17, the engaging portion 23 and the second flange 24 so that the pivot does not separate from the two bases 10 which are pivotably connected to each other.

While we have shown and described the embodiment in accordance with the present invention, it should be clear to those skilled in the art that further embodiments may be made without departing from the scope of the present invention.

What is claimed is:

1. A tool holder assembly comprising:
at least two bases pivotably connected to each other and each base having a first pivotal portion formed axially thereto, a first passage defined through the first pivotal portion, and a second pivotal portion formed axially thereto, the second pivotal portion having an open side, two extensions respectively extending from laterally from a top end and a bottom end of the second pivotal portion, each extension having a hole defined therethrough, and
one of multiple pivots extending through the two holes of the two extensions of one of the at least two bases and the first passage of another one of the at least two bases to pivotably connect the at least two bases, each of the at least two bases having one tool extending through the first passage thereof.

2. The tool holder assembly as claimed in claim 1, wherein a first recessed area is defined in a top of the extension that extends from the top end of each of the at least two bases, the first recessed area communicates with the hole corresponding thereto, a first shoulder formed at a connection portion between the first recessed area and a periphery of the hole corresponding thereto, a second recessed area is defined in a bottom of the extension that extends from the bottom end of each of the at least two bases, the second recessed area communicates with the hole corresponding thereto, a second shoulder formed at a connection portion between the second recessed area and a periphery of the hole corresponding thereto, each pivot is a cylindrical member and has a second passage, a first flange and a second flange respectively extend radially from two ends of each pivot, the tool extends through the second passage, the pivot extends through the two holes of the two extensions of one of the at least two bases, and the first pivotal portion of another one of the at least two bases, the first flange is engaged with the first recessed area and has an engaging portion on an underside thereof, the engaging portion is rested on the first shoulder, the second flange is rested on the second shoulder, the pivot is restricted by the first and second shoulders, the engaging portion and the second flange so as not to be separated from the base corresponding thereto.

3. The tool holder assembly as claimed in claim 1, wherein the second passage of each pivot includes a restriction portion extending from an inner periphery thereof so as to position the tool in the second passage.

4. The tool holder assembly as claimed in claim 1, wherein the tool is a hexagonal wrench.

5. The tool holder assembly as claimed in claim 1, wherein the pivot is integrally formed with the base corresponding thereto.

6. The tool holder assembly as claimed in claim 1, wherein the at least two bases have different sizes, two respective inner diameters and two respective lengths of the first passages of the at least two bases are different from each other so as to receive the tools of different sizes.

7. The tool holder assembly as claimed in claim 1, wherein the first recessed area of each of the at least two bases is a non-circular area, the first flange is a non-circular flange so as to be engaged with the first recessed area.

8. The tool holder assembly as claimed in claim 1, wherein a number of the at least two bases is 3, 4, 5, 6, 7, 8, 9, 10 or 12.
